(19) United States
(12) Patent Application Publication
(10) Pub. No.: US 2011/0020621 A1
(43) Pub. Date: Jan. 27, 2011

(54) GLASS-TYPE SUBSTRATE COATED WITH THIN LAYERS AND PRODUCTION METHOD

(75) Inventors: Dominique Coster, Jumet (BE); Alain Schutz, Moustier (BE); Pieter Jacot, Moustier (BE); Jean-Francois Ruelle, Moustier (BE); Xavier Dognies, Moustier (BE); Daniel Decroupet, Jumet (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Glass Europe, Bruxelles (BE)

(21) Appl. No.: 12/933,268

(22) PCT Filed: Mar. 17, 2009
(86) PCT No.: PCT/EP09/53137

§ 371 Date: Sep. 17, 2010

(30) Foreign Application Priority Data
Mar. 18, 2008 (EP) 08152955.4

(51) Int. Cl. B32B 17/06

(52) U.S. Cl. 428/213; 428/432

(57) ABSTRACT

A transparent glass-type substrate coated with a stack of thin layers, constituting for example a conductive substrate for solar cells, for example photovoltaic cells, and a method for producing such a substrate. The stack of thin layers includes an underlayer, a conductive layer of which has a thickness between 200 and 1000 nm, an upper layer of which has a refractive index between 1.45 and 2.2 and a thickness between 5 and 300 nm. The substrate and the stack are such that the haze is lower than 5%, the transmission value between 450 and 850 nm minus the haze being greater than 70% or even 74%. The substrates combine contradictory electrical and optical properties of: high electrical conductivity, the presence of a buffer layer, and high light and solar transmission.

The present invention relates to a transparent glass-type substrate coated with a stack of thin layers, constituting in particular a conductive substrate for solar cells, in particular for photovoltaic cells. The present invention also relates to a method for producing such a substrate.

Glass-type substrates coated with transparent conductive layers (low emissivity (low-e), antistatic) are known. For example, layers based on indium tin oxide (In203:Sn, ITO), doped zinc oxide or doped tin oxide (in particular with antimony or fluorine) are well-known for their electrical conductivity properties.

In addition, solar cells based on thin layers are generally composed of two conductive layers or electrodes encapsulating a stack of layers forming the photoconversion cell. At least one of the two electrodes should be transparent and is usually called TCO (Transparent Conducting Oxide). The transparent electrode is deposited on a glass substrate enabling the assembly of layers to be protected.

In Particular, photoconversion cells exist based on a light absorbing layer made of amorphous silicon, based on microcrystalline silicon or based on cadmium telluride. In the latter case, a layer of cadmium sulphide is generally deposited between the transparent electrode and the cadmium telluride layer.

In order to provide a glass-type substrate coated with a conductive layer that can act as an electrode on which the photoconversion cell may be deposited, properties of high conductivity should be combined with special optical properties enabling the photoconversion cell to receive the maximum solar energy.

These properties are contradictory, since in order to increase conductivity it is necessary to increase the thickness of the conductive layer, the consequence of which is the reduction of light transmission. A reduction in light transmission reduces the quantity of solar energy reaching the photoconversion cell.

It is known that layers based on tin oxide deposited by pyrolysis on glass (in the vapour phase (CVD), in the liquid phase (spraying) or in the solid phase (powder spraying) generally give a whitish haze. This haze is mainly the result of light scattering occurring at the irregular interface between the tin oxide layer and the medium in contact with this layer.

In some cases, a high haze or rough surface is desired in order to increase the light scattering effect. In document EP 1 056 136, it is proposed to increase the haze by providing a structure:
glass/SnO₂/SiO₂/SnO₂:F/photoconversion structure (Si)/rear electrode
   where the SnO2 layer has holes, so as to obtain irregularities at the surface of the conductive layer. A haze of 7.5 to 11% is obtained in this way.

In documents WO2006/121601 & WO2007/106226, it is also proposed to increase the light scattering effect by providing a structure:
extra-clear glass/ZnO for a solar cell,
   where the surface of the glass substrate may be made irregular (patterned).

Structures for solar cells are also known comprising:

a glass-type substrate/a conductive layer (Cd₂SnO₄ or SnO₂:F, etc.)/a buffer layer/CdS/CdTe/rear electrode.

The low conductivity buffer layer makes it possible to increase the efficiency of the cell by enabling the thickness of the CdS layer to be reduced. It is in point of fact of value to minimize the thickness of the CdS layer on account of its absorption which prevents light reaching the CdTe layer. The use of an electrically insulating layer between the conductive layer and the CdS layer makes it possible to prevent direct contact between the conductive layer and the CdTe layer, should the very thin CdS present a local pinhole.

In document WO 00/14812, the following structure is described:
Glass/Cd₂SnO₄/Zn₂SnO₄ (20-300 nm)/CdS/CdTe.

In that document, no indication is given as to the thickness of the conductive layer, or as to the implications of this thickness on the light and solar transmission of the stack and on the required conductive properties.

In documents WO 93/14524 & WO 95/03630, the following structure is described:
Glass/optionally barrier layer for Na+/SnO₂:F (0.4-1μ)/SnO₂/CdS/CdTe.

The buffer layer as described should have low conductivity (1.25×10⁻³ to 100 mho/cm), and is preferably based on SnO₂ and has a thickness of 0.8 μm.

It has been discovered that a layer of such a thickness has the disadvantage of reducing light and solar transmission and of increasing haze. The efficiency of the solar cell is therefore affected by this buffer layer. Moreover, the high thickness of the buffer layer has a negative effect on the durability of the stack. The greater the increase in the thickness of both tin oxide based layers, the more the internal pressure increase. In particular, when the layer is subjected to mechanical or chemical stress (among others, humidity) the thick layer could have the tendency to delaminate. Such a layer is also difficult to deposit since it requires a large flow of reactants. Given that the speed of the glass (under the coater) reaches 10-18 m/min or even more, it has been discovered that it is particularly difficult to deposit such a layer with little haze.

In WO 93/14524, the buffer layer based on SnO₂ must be doped with a doping element (Zn, In, Ga, Al) different from the dopant of the conductive layer. Doping of SnO₂ with these elements is particularly complicated and no industrial method is available at the present time.

In US2003/0011047, the following structure is described:

Glass/SnO2:F (500 nm)/SnO2:Zn (30 nm)/CdS/CdTe

No underlayer is described. The SnO2:Zn buffer layer should preferably be deposited by DC sputtering. This renders the manufacturing process more complex when the conductive layer is deposited on line by pyrolysis.

The buffer layer may be textured for example by acid etching or any other known method.

A structure for a solar cell (based on silicon) is also known from WO 07/027,498, comprising a structure:
Glass/SnO₂/SiO₂/SnO₂:F (530-730 nm)/TiO₂ (30-60 nm)

The TiO₂ layer makes it possible to reduce the light reflection of the structure on the glass side, and in this way to increase the light transmission of the structure. More generally, a layer having an index between 2.3 and 3.5 is required for optimizing the light transmission of the stack. The light reflection obtained on the layer side is 5.2-8.0%.

However, this structure is not suitable for a photoconversion cell based on CdS/CdTe.

The object of the present invention is to provide a structure for solar cells comprising a glass substrate coated with a stack of layers that simultaneously combines the properties of high conductivity and optical properties that make it possible to improve the yield of solar cells.

The inventors have found that it is possible to provide a transparent conductive substrate that simultaneously combines the advantages of the use of a buffer layer between the conductive layer and the photoconversion cell, while maintaining high conductivity properties and optical properties that permit the best possible yield of the photoconversion cell.

The subject of the present invention is a transparent glass-type substrate coated with a stack of thin layers that comprises at least:
i) An underlayer;
ii) a conductive layer of which the thickness lies between 200 and 1000 nm;
iii) an upper layer of which the refractive index lies between 1.45 and 2.2 and of which the thickness lies between 5 and 300 nm;
   the substrate and the stack being such that the haze, measured according to Standard D1003-95, is lower than 5%.

It has been found that, at least in some cases, too much haze decreases the yield of the solar cell.

Another subject of the present invention is a method for producing a transparent conductive substrate consisting of a glass substrate coated with a stack of layers, characterized by the following steps:

a) a conductive layer based on SnO₂ doped with fluorine is deposited by pyrolysis, using a vaporized mixture of the following precursors: a source of tin, a source of fluorine and water; the volume ratio between the source of tin and water being between 0.06 and 10, preferably between 0.1 and 5, and even more preferably between 0.3 and 2.
b) an upper layer based on tin oxide is deposited by pyrolysis using a vaporized mixture of a source of tin and water; the volume ratio between the source of tin and water being between 0.4 and 4, preferably between 0.6 and 3.

The subject of the present invention is in particular described in the sub-claims.

In particular, the transmission value between 450 and 850 nm minus the haze is greater than 70%, preferably greater than 74%, or yet more preferably even greater than 76%.

In particular, the subject of the present invention is as defined in the subclaims.

The conductive layer is preferably based on tin oxide doped with fluorine and the upper layer is chosen in particular from tin oxide, silicon oxide or aluminium oxide. It is also possible to have simultaneously a layer based on tin oxide and an additional layer based on silicon oxide.

When the upper layer is based on tin oxide, it may contain impurities or dopants; however, the quantity of its dopants is then advantageously less than the quantity of dopants of the conductive layer. In particular, the ratio between the percentage of dopants in the upper layer and the percentage of dopants in the conductive layer is less than 0.5, preferably less than 0.2, and even more preferably less than 0.1.

The stack includes an underlayer situated between the substrate and the conductive layer. This underlayer advantageously has a refractive index (measured at 550 nm) of between 2.0 and 3.0, preferably between 2.2 and 2.7. In particular, the underlayer is based on TiO₂. It may have a thickness between 4 and 30 nm, preferably between 5 and 20 nm and even more preferably between 7 and 16 nm. Its optical thickness (thickness×refractive index) advantageously lies between 10 and 50 nm and even more advantageously between 12 and 40 nm.

In order to obtain the lowest possible resistivity, the conductive layer preferably has a thickness greater than 330 nm, preferably greater than 400 nm and even more preferably greater than 450 nm. On the other hand, for optical reasons, the conductive layer preferably has a thickness less than 700 nm and preferably less than 600 nm.

The thickness of the upper layer is preferably greater than 10 nm, even more preferably greater than 20 nm and less than 160 nm, preferably less than 100 nm.

In particular, the light transmission (TLD65, 2°) of the coated substrate is greater than 77% or even 78% and preferably greater than 79%.

The substrate may be a clear soda lime glass or extra-clear soda lime glass. By clear soda lime glass, it is generally understood a glass substrate which has a light transmission in the visible around 88 or 89% (for a thickness of 3 to 4 mm). By extra-clear soda lime glass, it is generally understood a substrate of which the total iron content is less than 0.040 wt % Fe₂O₃, preferably less than 0.020 wt % Fe₂O₃ and more preferably less than 0.015 wt % Fe₂O₃. A glass substrate may also be characterized by its light transmission and its solar transmission. For the present invention, the substrate may advantageously be chosen from substrates having a light transmission (TL, D65—4 mm) greater than 90.0%, preferably greater than 90.5% and even more preferably greater than 91.0%, or from substrates having a solar transmission (TE EN410—4 mm) greater than 86.5%, preferably greater than 88.5%, and even more preferably greater than 89.5%. Such substrates are considered as extra-clear soda lime glass.

The inventors have found that the coated substrate according to the invention should have the lowest possible haze, in particular less than 5%, preferably less than 2%, and even more preferably less than 1.5%. This is not obvious because the general teaching of the prior art requires or prefers at the opposite textured surfaces or, rough or irregular surfaces.

The coated substrate according to the invention advantageously has the lowest possible sheet resistance, preferably less than 20 ohm/sq, more preferably less than 14 ohm/sq, and even more preferably less than 12 ohm/sq, in order to limit ohmic losses. Once photons have been transformed into electrons by the photoconversion cell, the resulting current may thus circulate as freely as possible with the least possible ohmic loss.

The coated substrate according to the invention advantageously has a ratio (transmission between 450 and 850 nm minus haze)/sheet resistance (expressed in ohm/sq), greater than 6.5, preferably greater than 7 and even more preferably greater than 8.

The coated substrate according to the invention is particularly useful for application of a photo-conversion cell based on CdS/CdTe.

Other layers may be added, in particular an intermediate layer between the underlayer and the conductive layer. This is for example based on SiO₂ or SiOxCy and may have a thickness between 10 and 100 nm, preferably between 20 and 50 nm.

The stack may include a supplementary layer, of which the thickness may be between 10 and 100 nm, preferably between 15 and 50 nm.

### EXAMPLES

### Example 1

An underlayer of TiO₂ was deposited by gas phase pyrolysis (CVD) on a float ribbon of extra clear soda lime glass (3.15 mm thick, TL (D 65, 2°)=90.9%). The precursor used was titanium tetraisopropoxide (TTIP). The layer was deposited when the glass ribbon was at a temperature of approximately 660-700°.

A second layer based on tin oxide doped with fluorine was deposited on the first layer, when the glass ribbon was at a temperature of approximately 600-640° C. The main precursor used is monobutyltin trichloride (MBTC), to which a source of fluorine is added (which can be hydrofluoric acid (HF), trifluoroacetic acid, ammonium bifluoride, nitrogen trifluoride (NF3), dichloro-difluoromethane (CF2C12), tetrafluoromethane CF4, . . . ) and water. In order to provide optimum smoothness, the volume ratio MBTC/H₂O was approximately 1.3 and the molar ratio approximately 0.14.

A third non-doped layer of tin oxide was deposited on the conductive layer, when the glass ribbon was at a temperature of approximately 550-600° C. The precursors used were MBTC and water. The volume ratio MBTC/H₂O was approximately 2.

Four samples were prepared according to this example 1. The optical properties (average transmission between 450 and 850 nm, light transmission (measured under illuminant D65, and solid observation angle of 2°), haze measured according to standard D1003-95 (white light source) (BYK-Gardner haze-grade type) and conductivity (sheet resistance) of the stack were measured. The table below gives the results obtained as well as the thicknesses of the various layers and the values T-H (percentage transmission between 450 and 850 nm from which the percentage haze has been subtracted) and T-H/R (result of dividing the value T-H by the sheet resistance expressed in ohm/sq.)

### Example 2

The same stack was produced as in example 1 but the volume ratio MBTC/H₂O of the second layer was approximately 0.83 and the molar ratio 0.09. The results are also given in the table below.

### Example 3

The same stack as in example 1 was produced but the substrate was a clear normal glass (TL(D65, 2°)=90.5%) with the same thickness, and the volume ratio MBTC/H₂O of the second layer was approximately 0.56 and the molar ratio 0.06.

The samples of example 3 were also subjected to a durability test, of the Damp Heat Bias (DHB) type which made it possible to measure the risk of the layers delaminating.

This test consists of subjecting samples coated with thin layers to simultaneous electrical and thermal attack. The coated glass samples were heated the time necessary to stabilize them to a fixed temperature and then subjected to an electric field.

The samples 3a to 3e were placed between two electrodes, the uncoated face in contact with a graphite electrode (anode) and a copper electrode covered with aluminium (cathode) placed on the coated face of the samples. The parameters were set in the following way: voltage 200 volts, temperature=150° C., duration of application of the electric voltage: 15 min. After cooling to room temperature, the samples are exposed during one hour to 100% relative humidity continuously condensing on the coated side (condensing humidity, water temperature equals about 55° C. and vapour temperature equals 50° C.±2° C.). The area of the sample that had peeled was measured. The table below gives the percentage of the area of the coated sample that had peeled.

### Example 4

The same stack as in example 1 was produced on the same extra clear substrate as in example 1. The volume ratio MBTC/H₂O of the second layer (SnO2:F) was approximately 1.6. For the third layer (SnO2), it was 0.8.

### Example 5

The same stack as in example 1 was produced on the same normal clear glass as in example 3. The volume ratio MBTC/H₂O of the second layer (SnO2:F) was approximately 1.6. For the third layer (SnO2), it was 0.8.

TABLE 1

| | TiO₂ | SnO₂:F | SnO₂ | | TL D65, | | R | T-H | | |
|---|---|---|---|---|---|---|---|---|---|---|
| Ex. | (nm) | (nm) | (nm) | T_{450-850 nm} (%) | 2° (%) | Haze (%) | (ohm/sq) | (%) | DHB (%) | (T-H)/R |
| 1a | 12 | 510 | 66 | 77.4 | 76.9 | 0.46 | 9.9 | 76.9 | | 7.8 |
| 1b | 12 | 480 | 66 | 78.1 | 77.9 | 0.36 | 10.6 | 77.7 | | 7.3 |
| 1c | 11 | 505 | 66 | 77.4 | 76.9 | 0.43 | 9.9 | 77.0 | | 7.8 |
| 1d | 12 | 545 | 66 | 76.6 | 77.2 | 0.48 | 8.9 | 76.1 | | 8.6 |
| 2a | 12 | 570 | 66 | 79.1 | 80.0 | 0.53 | 8.7 | 78.6 | | 9.0 |
| 2b | 11 | 530 | 47 | 79.5 | 79.7 | 0.91 | 10.0 | 78.6 | | 7.9 |
| 3a | 13 | 560 | 47 | 77.8 | 79.4 | 0.60 | 9.5 | 77.2 | 0 | 8.2 |
| 3b | 10 | 575 | 47 | 77.9 | 79.5 | 0.62 | 9.0 | 77.3 | 25 | 8.6 |
| 3c | 13 | 560 | 47 | 77.6 | 79.0 | 0.65 | 8.8 | 76.9 | 0 | 8.7 |
| 3d | 4 | 565 | 47 | 78.4 | 80.0 | 0.72 | 9.2 | 77.7 | 35 | 8.4 |
| 3e | 11 | 555 | 50 | 78.1 | 79.7 | 0.62 | 9.9 | 77.5 | 0 | 7.8 |
| 4a | 10 | 540 | 42 | 78.6 | 79.9 | 0.73 | 8.4 | 77.8 | | 9.3 |
| 4b | 11 | 520 | 45 | 78.9 | 80.4 | 0.90 | 9.4 | 78.0 | | 8.3 |
| 5a | 10 | 508 | 56 | 74.7 | 77.3 | 0.57 | 8.3 | 74.1 | | 8.9 |
| 5b | 11 | 512 | 56 | 74.7 | 77.3 | 0.57 | 8.5 | 74.1 | | 8.8 |
| 5c | 10 | 464 | 59 | 75.0 | 76.3 | 0.42 | 8.8 | 74.6 | | 8.4 |

### Example 6

A 4-layer stack (TiO2/SiO2/SnO2:F/SnO2) has been deposited by gas phase pyrolysis (CVD) on a float ribbon of normal clear soda lime glass (as in example 3) of 3.15 mm thick.

For the first layer the precursor used was titanium tetraisopropoxide (TTIP). The layer was deposited when the glass ribbon was at a temperature of approximately 650-750°.

A second layer of SiO2 was deposited on the first layer when the glass ribbon was at a temperature comprised between 580° C. and 700° C. The precursors used were SiH₄ mixed with ethylene and or CO₂ and carrier gas.

A third layer based on tin oxide doped with fluorine was deposited on the second layer, when the glass ribbon was at a temperature of approximately 520-640° C. The precursors used were monobutyltin trichloride (MBTC), hydrofluoric acid (HF) and water. In order to provide optimum roughness, the volume ratio MBTC/H₂O was approximately 1.6

A fourth non-doped layer of tin oxide was deposited on the conductive layer, when the glass ribbon was at a temperature of approximately 500-600° C. The precursors used were MBTC and water. The volume ratio MBTC/H₂O was approximately 0.8.

The results are summarised in the following table.

TABLE 2

| | TiO₂ | SiO2 | SnO₂:F | SnO₂ | | TL D65, | | R | T-H | |
|---|---|---|---|---|---|---|---|---|---|---|
| Ex. | (nm) | (nm) | (nm) | (nm) | T_{450-850 nm} (%) | 2° (%) | Haze (%) | (ohm/sq) | (%) | (T-H)/R |
| 6a | 12 | 22 | 433 | 20 | 76.9 | 78.7 | 0.49 | 8.8 | 76.4 | 8.7 |
| 6b | 12 | 22 | 433 | 25 | 76.8 | 78.5 | 0.57 | 9.2 | 76.2 | 8.3 |
| 6c | 12 | 22 | 433 | 30 | 76.4 | 78.1 | 0.53 | 9.5 | 75.9 | 8.0 |
| 6d | 12 | 22 | 433 | 45 | 75.3 | 77.0 | 0.74 | 9.0 | 74.6 | 8.2 |
| 6e | 12 | 22 | 433 | 60 | 75.1 | 77.0 | 0.71 | 9.3 | 74.4 | 8.0 |

It was unexpectedly found that in spite of the large thickness of the SnO₂:F layer, and the addition of a buffer layer based on SnO₂, haze was maintained at very low values and transmission between 450 and 850 nm remained quite high.

These stacks thus surprisingly combined contradictory electrical and optical properties: high electrical conductivity, the presence of a buffer layer capable of receiving a photoconversion cell, in particular CdS/CdTe, and high light and solar transmission.

Further advantages may be observed with the addition of the intermediate layer between the underlayer and the conductive layer:

a good blocking of the Na+ ions migration. This is particularly important during the deposition of the CdS/CdTe photovoltaic materials which involves high temperature (450-600° C.);
good optical properties (neutralization and/or suppression of the color in reflection, which improves the aesthetics of the coated glass and photovoltaic panel.

1. Transparent glass-type substrate coated with a stack of thin layers that comprises at least:
an underlayer;
a conductive layer of which the thickness lies between 200 and 1000 nm;
an upper layer of which the refractive index lies between 1.45 and 2.2 and of which the thickness lies between 5 and 300 nm;
the substrate and the stack being such that the haze of the coated substrate, measured according to Standard D1003-95, is lower than 5%.

2. Coated substrate according to claim 1, wherein the conductive layer is based on tin oxide doped with fluorine.

3. Coated substrate according to claim 1, wherein the upper layer is chosen from tin oxide, silicon oxide or aluminium oxide and may be doped or not.

4. Coated substrate according to claim 3, wherein the upper layer is a layer of tin oxide of which the doping ratio in relation to the conductive layer is a maximum of ½ and preferably ⅕ and preferably 1/10.

5. Coated substrate according to claim 1, wherein the upper layer is a layer of undoped tin oxide.

6. Coated substrate according to claim 1, wherein the underlayer is based on a material of which the refractive index lies between 2.0 and 3.0, preferably between 2.2 and 2.7.

7. Coated substrate according to claim 1, wherein the underlayer is based on TiO₂.

8. Coated substrate according to claim 1, wherein the thickness of the underlayer lies between 4 and 30 nm, preferably between 5 and 14 nm and even more preferably between 6 and 12 nm.

9. Coated substrate according to claim 1, wherein the thickness of the conductive layer lies between 330 and 700 nm, preferably between 400 and 600 nm, and even more preferably between 450 and 600 nm.

10. Coated substrate according to claim 1, wherein the thickness of the upper layer lies between 10 and 160 nm and preferably between 15 and 100 nm.

11. Coated substrate according to claim 1, wherein the substrate is a soda lime glass of which the total iron content is less than 0.040 wt % Fe₂O₃, preferably less than 0.020 wt % Fe₂O₃, and even more preferably less than 0.015 wt % Fe₂O₃.

12. Coated substrate according to claim 1, wherein the haze lies between 0.0 and 5%, preferably between 0.1 and 2%, and even more preferably between 0.2 and 1.5%.

13. Coated substrate according to claim 1, wherein the stack has a sheet resistance between 5 and 20 ohm/sq, preferably between 6 and 14 ohm/sq, and even more preferably between 7 and 12 ohm/sq.

14. Coated substrate according to claim 1, further comprising an intermediate layer between the underlayer and the conductive layer.

15. Coated substrate according to claim 14, wherein the intermediate layer is based on SiO₂ or SiOxCy.

16. Coated substrate according to claim 14, wherein the intermediate layer has a thickness between 10 and 100 nm, preferably between 20 and 50 nm.

17. Coated substrate according to claim 1, such that the transmission between 450 and 850 nm minus the haze is greater than 70%, preferably greater than 74% and even more preferably even greater than 76%.

18. Coated substrate according to claim 1, wherein the result of dividing (the transmission between 450 and 850 nm minus the haze) by the sheet resistance expressed in ohm/sq, is greater than 6.5, preferably greater than 7 and even more preferably greater than 8.

19. Method for producing a transparent conductive substrate consisting of a glass substrate coated with a stack of layers, comprising:
a) a conductive layer based on SnO₂ doped with fluorine is deposited by pyrolysis, using a vaporized mixture of the following precursors: a source of tin, a source of fluorine and water; the volume ratio between the source of tin and water being between 0.06 and 10, preferably between 0.1 and 5, and even more preferably between 0.3 and 2.
b) an upper layer based on tin oxide is deposited by pyrolysis using a vaporized mixture of a source of tin and water; the volume ratio between the source of tin and water being between 0.4 and 4, preferably between 0.6 and 3.

20. Method according to claim 19, wherein the tin precursor is identical for the conductive layer and for the upper layer.

21. Method according to claim 19, wherein the source of tin is chosen from organic or organo-chlorinated tin precursors.
